(19) United States
(12) Patent Application Publication
(10) Pub. No.: US 2007/0286671 A1
(43) Pub. Date: Dec. 13, 2007

(54) BICYCLE SEAT POST

(75) Inventor: MARIO MEGGIOLAN, CREAZZO (VICENZA) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.L., VICENZA (IT)

(21) Appl. No.: 11/758,443

(22) Filed: Jun. 5, 2007

(30) Foreign Application Priority Data
Jun. 8, 2006 (IT) MI2006A001110

(51) Int. Cl. F16L 41/00

(52) U.S. Cl. 403/230

(57) ABSTRACT

A bicycle seat post is provided comprising a tubular element adapted to support the saddle of a bicycle and grasping means of a portion of a frame of the seat adapted to be rotatably coupled with the tubular element to allow the positioning of the grasping means in a plurality of operating positions defined about an axis perpendicular to a plane of longitudinal symmetry of the frame of the bicycle. The tubular element comprises first holding means of the grasping means and the grasping means comprise second holding means operatively coupled with the aforementioned first holding means to prevent the movement of the grasping means along the axis. Preferably, the coupling between the first and second holding means takes place through respective coupling surfaces having a matching shape.

### FIELD OF INVENTION

The present invention relates to a bicycle seat post. In particular, the invention concerns an adjustable seat post for a racing bicycle.

Throughout the present description and in the subsequent claims, the expression “bicycle seat post” is used to mean the component of the bicycle that supports the seat on the bicycle frame. In particular, “adjustable seat post” means a seat post that allows the position of the seat to be adjusted with respect to the bicycle frame.

### BACKGROUND

In the field of bicycles generally and, in particular, of racing bicycles, the use of adjustable seat posts is widespread. The ideal position of the seat is that which allows the most advanced leg of the cyclist to bend at 90° when the pedals are aligned horizontally and allows the cyclist's chest to assume a comfortable position when the arms rest on the handlebars.

Of course, the ideal position of the seat depends upon the physiognomy of the cyclist, in particular the length of the cyclist's legs and arms, therefore it is essential to provide an adjustable seat post.

### SUMMARY

The present invention relates to a bicycle seat post, comprising:

a tubular element adapted to support a seat, or saddle, of a bicycle, and

a clamp of a portion of a frame of the seat adapted to be rotatably coupled with the tubular element to allow the clamp to be positioned in a plurality of operating positions defined about an axis X-X perpendicular to a plane of longitudinal symmetry of the frame of the bicycle,

wherein the tubular element comprises first holding surfaces of the clamp and the clamp comprises second holding surfaces operatively coupled with the first holding surfaces to prevent a movement of the clamp along the axis X-X.

### BRIEF DESCRIPTION OF THE DRAWING(S)

Further characteristics and advantages of the present invention shall become clearer from the following detailed description of some preferred embodiments thereof, given as a non-limiting example with reference to the attached drawings. In such drawings:

FIG. 1 is a schematic side view of a bicycle that comprises a seat post in accordance with the present invention;

FIG. 2 is an exploded perspective view of a first embodiment of the seat post of the present invention;

FIGS. 3 to 10 are plan views of variants of the tubular element of a seat post according to the present invention;

FIGS. 11 and 12 are plan views of variants of a jaw element adapted to respectively couple with the tubular element of FIGS. 3 and 4;

FIG. 13 is an exploded perspective view of an alternative embodiment of the seat post of the present invention; and

FIG. 14 is a perspective view of an alternative embodiment of the seat post of the present invention.

### DETAILED DESCRIPTION OF THE PREFERRED EMBODIMENT(S)

### Introduction

In the seat post of the present invention, any possibility of relative movement between the grasping means and the tubular element in a direction perpendicular to the plane of longitudinal symmetry of the bicycle frame is eliminated. In particular, such a movement is properly blocked by the contrasting action applied by the mechanical coupling between the first holding means of the grasping means provided on the tubular element and the second holding means provided in the grasping means. The grasping means can therefore rotate about the axis X-X to allow the adjustment of the inclination of the seat with respect to the tubular element, but they cannot move perpendicular to the plane of longitudinal symmetry of the bicycle frame.

Preferably, the tubular element comprises a seat for coupling with the aforementioned grasping means. The first holding means are in this case defined in such a coupling seat. In turn, the grasping means preferably comprise a coupling member with the coupling seat. The second grasping means are in this case defined in such a coupling member.

In a seat post having the aforementioned preferred features, the mechanical coupling between the tubular element and the grasping means is thus made by coupling together the surface of the coupling seat provided in the tubular element and the surface of the coupling member provided in the grasping means.

Even more preferably, the aforementioned coupling seat comprises a surface of revolution about the axis X-X and the first holding means are defined by at least one portion of the surface of revolution. The coupling member, on the other hand, preferably comprises an abutment surface adapted to cooperate in abutment against the surface of revolution and having a shape matching that of the surface of revolution. In this case, the second holding means are defined by at least one portion of the abutment surface. Advantageously, the coupling between matching surfaces ensures a stable, long-lasting, and repeatable mechanical coupling, in addition to the fact that it is easy to carry out at the assembly stage of the seat post.

In a preferred embodiment of the seat post of the present invention, the surface of revolution of the coupling seat of the tubular element is defined by the rotation about the axis X-X of a generatrix line having at least one inclined part with respect to such an axis X-X. In this case, the portion of the surface of revolution that defines the aforementioned first holding means is defined by the rotation about the axis X-X of the at least one inclined part. The matching abutment surface of the coupling member provided in the grasping means is also in this case defined by the rotation about a rotation axis parallel to the axis X-X of a generatrix line having at least one inclined part, the portion of the abutment surface that defines the aforementioned second rotation means being defined by the rotation of this latter inclined part about the respective rotation axis.

The inclined part of the aforementioned generatrices can, for example, be a rectilinear part. In this case the portion of the surface of revolution that defines the aforementioned first holding means and the portion of the abutment surface matching it and that defines the aforementioned second holding means preferably comprise respective conical surfaces that extend along the axis X-X.

The inclined part can alternatively be a curvilinear part. In this case the portion of the surface of revolution that defines the aforementioned first holding means and the portion of the abutment surface matching it and that defines the aforementioned second holding means preferably comprise respective curved surfaces that extend along the axis X-X.

Advantageously, the coupling between conical or curved surfaces extending along the axis X-X ensures the automatic centering of the grasping means in the coupling seat with respect to the axis X-X, as well as a high degree of obstruction to the translation of the grasping means along such an axis.

In a particularly preferred embodiment of the seat post of the present invention, the aforementioned generatrix line comprises two inclined parts having opposite inclination with respect to the plane of longitudinal symmetry of the bicycle frame. Advantageously, with such an operative configuration the relative translation of the grasping means with respect to the tubular element is prevented in both directions of the axis X-X.

Preferably, the portion of the surface of revolution that defines the aforementioned first holding means defines, on a plane passing through the axis X-X, a line having a substantially convex progression with respect to the axis X-X. Advantageously, in this case a seat post can be made in which the portion of coupling surface of the grasping means is thicker and therefore stronger.

However, a variant is foreseen in which the portion of the surface of revolution that defines the aforementioned first holding means defines, on a plane passing through the axis X-X, a line having a substantially concave progression with respect to the axis X-X.

The aforementioned generatrix line can be entirely inclined with respect to the axis X-X or can comprise at least one part substantially parallel to the axis X-X. In the first case, the surface of revolution of the coupling seat provided in the tubular element and its matching abutment surface of the coupling member provided in the grasping means are entirely defined by conical or curved surfaces. In the second case, on the other hand, the surface of revolution of the coupling seat provided in the tubular element and its matching abutment surface of the coupling member provided in the grasping means each comprise a portion of cylindrical surface and a portion of conical or curved surface, the portion of conical or curved surface defining the aforementioned holding means.

Preferably, the part substantially parallel to the axis X-X is arranged at least one free end of the generatrix line and, more preferably, at the opposite free ends of the generatrix line. The portion of conical or curved surface is thus defined in the coupling seat of the tubular element and in the coupling member of the grasping means in a substantially central position along the axis X-X that is near to the plane of longitudinal symmetry of the bicycle frame.

The aforementioned generatrix line can also comprise a gradual joining part between the part substantially parallel to the axis X-X and the inclined part, in order to avoid creating areas with high tension concentration on the coupling surfaces of the tubular element and of the holding means.

In an alternative embodiment of the seat post of the present invention, the surface of revolution of the coupling seat provided in the tubular element comprises at least one first portion of cylindrical surface extending along the axis X-X and a second portion of cylindrical surface extending along the axis X-X and having a diameter different to that of the at least one first portion of cylindrical surface. In such an embodiment, the aforementioned first holding means are defined by the second portion of cylindrical surface. Such a second portion of cylindrical surface defines, in the coupling seat defined in the tubular element, a throat (in the case in which the diameter of such a portion is larger than the diameter of the first portion of cylindrical surface) or a projection or step (in the case in which the diameter of such a portion is smaller than the diameter of the first portion of cylindrical surface) that cooperates with respectively a projection or a throat defined in the coupling member of the grasping means to offer the maximum degree of obstacle to the translation of the grasping means along the axis X-X.

Preferably, the at least one first portion of cylindrical surface is arranged at a free end of the surface of revolution and the second portion of cylindrical surface is arranged at the plane of longitudinal symmetry of the frame of the bicycle. More preferably, the second portion of cylindrical surface is arranged centrally with respect to two opposite end first portions of cylindrical surface.

A gradual joining surface can also be provided between the aforementioned at least one first portion of cylindrical surface and the aforementioned second portion of cylindrical surface, again in order to avoid creating areas with high tension concentration on the coupling surfaces of the tubular element and of the grasping means.

Preferably, the surface of revolution and the aforementioned abutment surface are symmetrical with respect to the plane of longitudinal symmetry of the bicycle frame.

In the preferred embodiment of the seat post of the present invention, the tubular element comprises, at a free end thereof, a first flange comprising the coupling seat and, on opposite sides to the coupling seat, a pair of fins extending cantilevered from the coupling seat.

Preferably, the grasping means comprise a clamp comprising an upper jaw element and a lower jaw element, and the aforementioned coupling member is defined by the lower jaw element. Preferably the grasping means comprise a second flange adapted to be coupled with the first flange through locking means, the clamp being arranged between the first flange and the second flange.

In the preferred embodiment of the seat post of the present invention, the second flange is made in a single piece with the upper jaw element, so as to reduce the number of components of the seat post and thus to make it easier to assemble and, at the same time, reducing the possibility of having undesired relative movements between the various components of the seat post. The second flange can, however, be made in a distinct piece from the upper jaw element. In this last case, the upper jaw element and the lower jaw element preferably mirror one another, so as to be interchangeable.

The tubular element is preferably made from a light metallic alloy or from composite material. The grasping means are preferably made from the same material from which the tubular element is made. In the most preferred embodiment of the seat post of the present invention, the tubular element and the grasping means are all made from composite materials.

### DETAILED DESCRIPTION

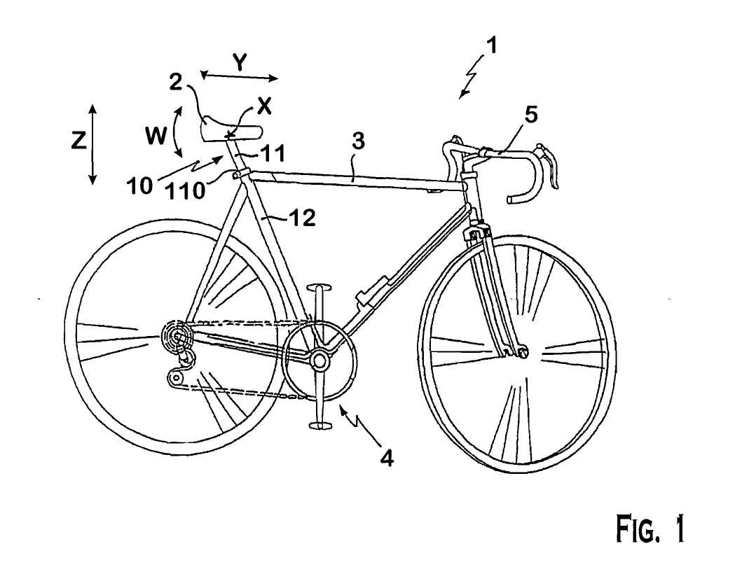

In FIG. 1, reference numeral 1 indicates a bicycle, in particular a racing bicycle. Such a bicycle 1 comprises a seat 2, also referred to as a saddle 2, associated with a frame 3 of the bicycle 1 through a seat post 10 in accordance with the present invention. The bicycle 1 also comprises a bottom bracket assembly 4 and handlebars 5, both of the conventional type.

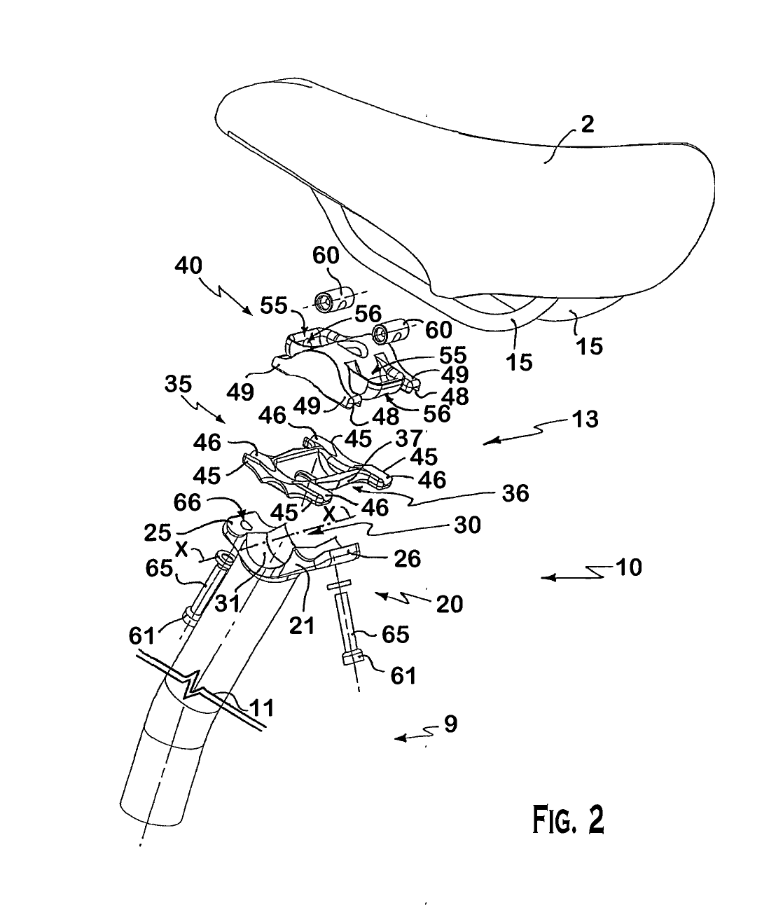

As better shown in FIG. 2, the seat post 10 comprises a seat tube 9 having a portion of a tubular element 11 adapted to be telescopically inserted, for at least part of the longitudinal extension thereof, in a suitable tubular seat 12 provided in the frame 3 of the bicycle 1 (FIG. 1) and a clamp 13 coupled with the tubular element 11 and adapted to grasp the seat 2 to associate it with the tubular element 11. In particular, the clamp 13 grasps the rods 15 of the frame of the seat 2.

The seat post 10 is an adjustable seat post. It therefore allows the position of the seat 2 to be adjusted in height (in the two ways of direction z in FIG. 1), in rotation about a horizontal axis X-X perpendicular to the plane of longitudinal symmetry of the frame 3 (as indicated by the arrow W in FIG. 1), and in a horizontal direction (as indicated by the arrow y in FIG. 1).

The adjustment of the position of the seat 2 takes place as described in U.S. patent application Ser. No. 11/639,481, filed Dec. 14, 2006, to the same Applicant, incorporated herein by reference.

With reference to FIG. 2, the seat tube 9 comprises, at a free end 20 of the tubular element 11, a fixed flange 21 for coupling with the clamp 13. The flange 21 is preferably made in a monolithic piece with the tubular element 11 or, according to a variant, it is coupled with the tubular element 11 through a caulk joint coupling, by gluing, through fastening elements, or any other system capable of generating a stable coupling.

The fixed flange 21 has a front fin 25 and a rear fin 26 (with reference to the position of the seat post 10 on the bicycle), placed on opposite sides of the tubular element 11. The fixed flange 21 comprises, between the two fins 25 and 26, a coupling seat 30 with the clamp 13 defined, at least in part, by a surface of revolution 31 obtained, ideally, by rotation of a generatrix line 90 about the axis X-X.

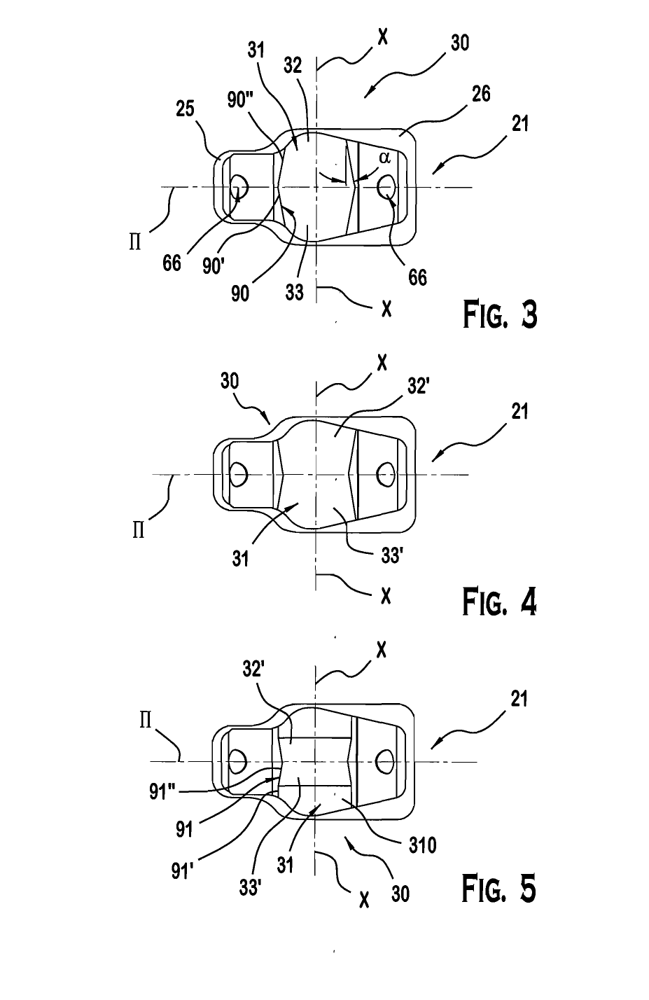

In the illustrated example in FIG. 2, of which FIG. 3 illustrates the plan of the flange 21 in greater detail, the surface of revolution 31 consists of the surface of two coaxial and opposite frustums of cone 32 and 33, in such a way that their bases coincide at the middle plane π of the fixed flange 21, such a middle plane coinciding with the plane of longitudinal symmetry of the frame 3 of the bicycle. The generatrix line 90 is formed in this case from two rectilinear parts 90′ and 90″ inclined with respect to the axis X-X and having opposite inclination with respect to the middle plane π of the flange 21.

In practice, the coupling seat 30 is convex with respect to the axis X-X, that is, with a progression that goes away from it, where the greatest deviation is at the middle plane π. In other words, the surface of the coupling seat 30 defines, on a plane passing through the axis X-X, a line having a substantially convex progression with respect to the axis X-X.

The conical surfaces 32 and 33 (and therefore the inclined parts 90′ and 90″ of the generatrix line 90) are preferably inclined with respect to the axis X-X by an angle α of between 0.5° and 20°, preferably between 1° and 10°.

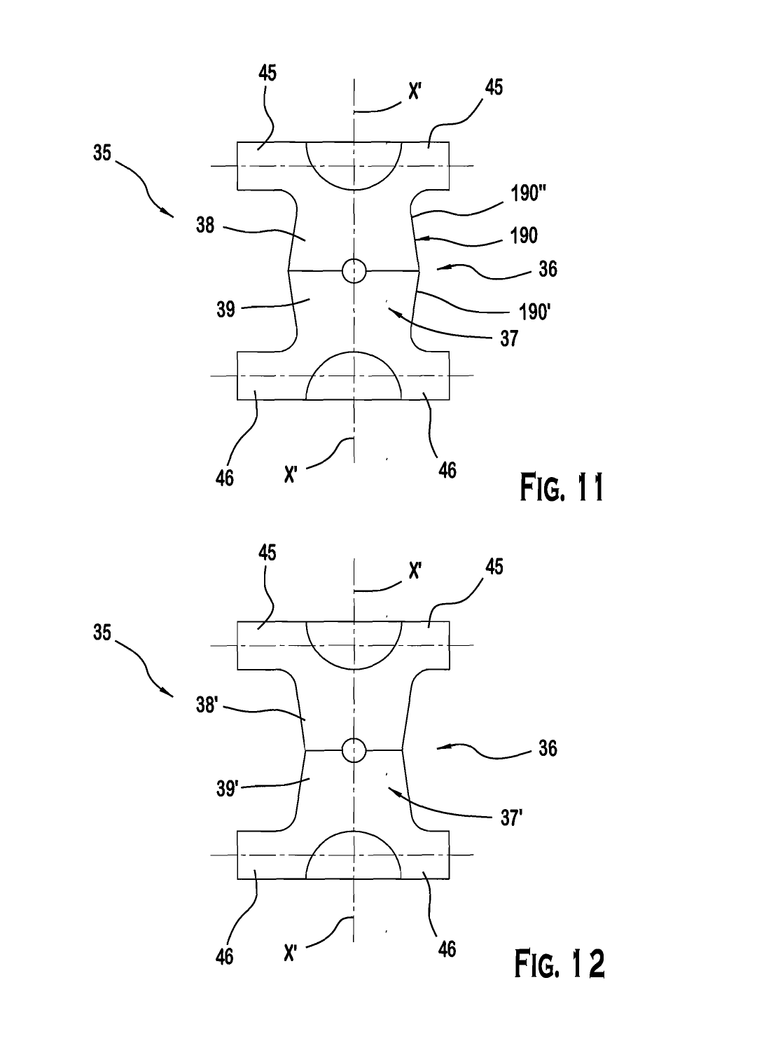

Again with reference to FIG. 2, the clamp 13 comprises a lower jaw element 35 and an upper jaw element 40. As better illustrated in FIG. 11, in which the lower jaw element 35 of FIG. 2 is represented in greater detail, the lower jaw element 35 has a coupling portion 36 adapted to operate in abutment against the coupling seat 30 of the flange 21. The coupling portion 36 is defined by an abutment surface 37 having a shape matching the surface of revolution 31. The abutment surface 37 thus consists of the surface of two coaxial and opposite frustums of cone 38 and 39, such frustums of the cones being defined by the rotation about a rotation axis X′-X′ parallel to the axis X-X of a generatrix line 190 having, as the generatrix line 90, two inclined parts 190′, 190″ with respect to the aforementioned rotation axis.

The lower jaw element 35 also comprises arms 45 projecting laterally from the coupling portion 36 and on which tracks 46 for the insertion of the rods 15 of the seat 2 are formed (FIG. 2).

The upper jaw element 40, in the example illustrated in FIG. 2, is a monolithic element comprising in a single piece the tracks 48 for the insertion of the rods 15 of the seat, preferably formed in arms 49 which are specular (i.e., mirror-like) to the arms 45, and holding means with respect to the fixed flange 21.

In particular, the holding means comprise two recesses 55, on the bottom of each of which a hole 56 is formed. In the recesses 55 cylinder nuts 60 are housed in which the stems of two screws 65 are screwed, respectively passing through the holes 56 and holes 66 formed in the fins 25 and 26 of the fixed flange 21. The heads 61 of the screws are held by the fins 25 and 26, for which reason the more the stems are screwed into the cylinder nuts 60 the more the upper jaw element 40 is locked against the fixed flange 21. Since the lower jaw element 35 is arranged between the flange 21 and the upper jaw element 40, the locking also traps the rods 15 of the seat 2 in the clamp 30.

Since the screws 65 can be screwed into the cylinder nuts 60 by different amounts, and since the lower jaw element 35 can rotate in the coupling seat 30 of the flange 21, the seat can be locked in multiple angular positions about the axis X-X.

Referring to the variants of FIGS. 4 to 10, elements corresponding to those of the previous figures are indicated with the same reference numerals.

FIG. 4 illustrates a variant of the flange 21 wherein the surface of revolution 31 of the coupling seat 30 again consists of a pair of frustums of cone 32′ and 33′, but orientated the opposite way with respect to what has been illustrated in FIG. 3, so as to form a coupling seat that widens going from the middle plane π towards the outside of the seat post along the axis X-X. In other words, in this case the surface of the coupling seat 30 defines, on a plane passing through the axis X-X, a line having a substantially concave progression with respect to the axis X-X.

FIG. 12 shows in detail the lower jaw element 35 adapted to be coupled with the flange 21 of FIG. 4. It should be noted how the abutment surface 37′ of the coupling portion 36 has a shape matching that of the surface of revolution 31 of the flange 21 of FIG. 4. In other words, the abutment surface 37′ consists of a pair of frustums of cone 38′ and 39′ orientated the opposite way with respect to what is illustrated in FIG. 11.

FIG. 5 illustrates a second variant of the flange 21 wherein the surface of revolution 31 of the coupling seat 30 is ideally defined by a broken generatrix line 91 that differs from the generatrix line 90 of FIG. 3 since it is only partly inclined with respect to the axis X-X. In this case, the surface 31 of the coupling seat 30 (and similarly the abutment surface of the lower jaw element 35) comprises a portion of cylindrical surface 310 generated by the rotation about the axis X-X of a part 91′ of the generatrix line 91 that is rectilinear and parallel to the axis X-X.

The part 91′ is arranged in an axially outer position with respect to an inclined part 91″ on opposite sides with respect to the middle plane π, so that the portions of conical surfaces 32′, 33′ are located in a substantially central position along the axis X-X, i.e., near to the middle plane π.

FIG. 6 illustrates a third variant of the flange 21 wherein the surface of revolution 31 of the coupling seat 30 is ideally defined by a curved generatrix line 92, for example a circle, ellipse, or parabola portion, symmetrical with respect to the middle plane π and such as to define a concave coupling seat 30 for rotation about the axis X-X.

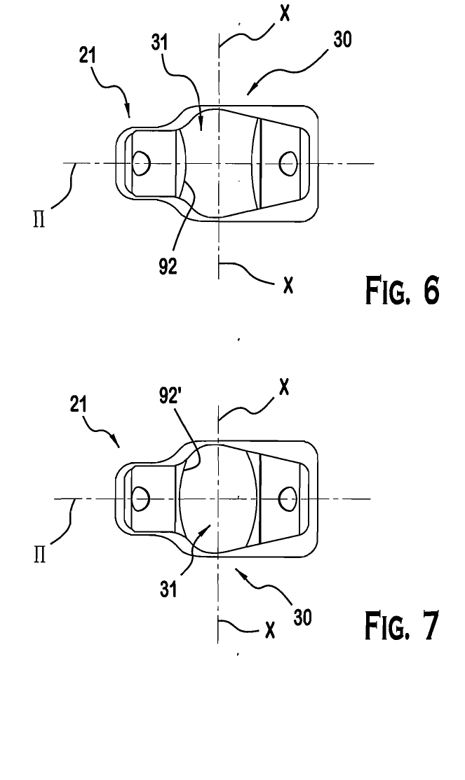

FIG. 7 illustrates a fourth variant of the flange 21 that differs from the one illustrated in FIG. 6 only in that the curved generatrix line 92′ defines a convex coupling seat 30 for rotation about the axis X-X.

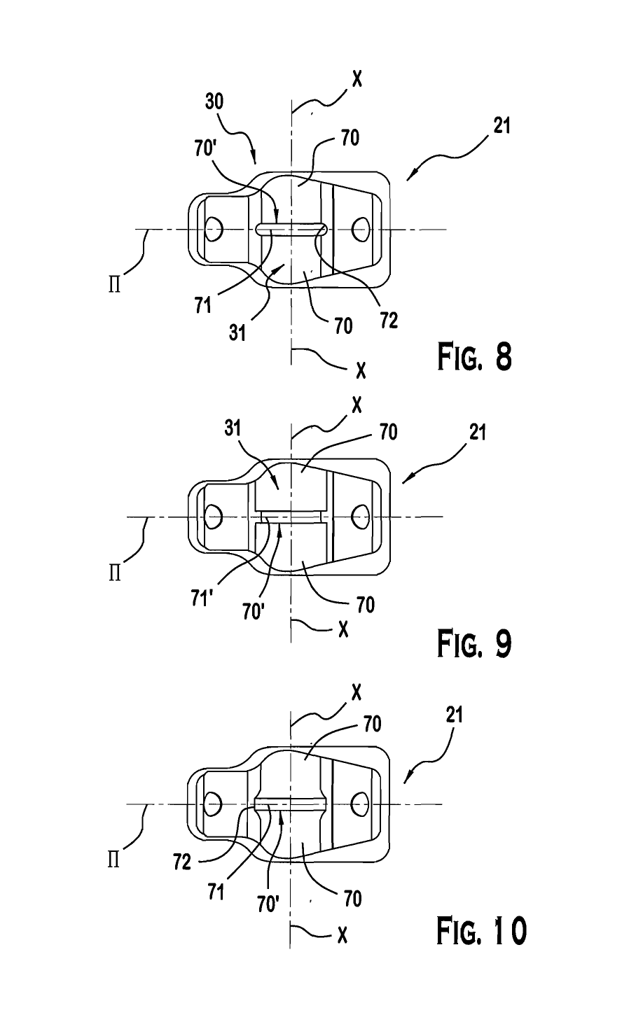

FIG. 8 illustrates a fifth variant of the flange 21 wherein the coupling seat 30 is defined by a portion of cylindrical surface 70 that extends according to the axis X-X, interrupted at the middle plane π by a throat 71 defined by a portion of cylindrical surface 70′ having a diameter larger than that of the portion of cylindrical surface 70. The throat 71 has the bottom 72 rounded and extends for the entire circumferential extension of the portion of cylindrical surface 70. In other words, the generatrix line that ideally defines the surface of revolution 31 of the seat 30 for rotation about the axis X-X is in part rectilinear and parallel to the axis X-X (in the part corresponding to the cylindrical portion 70) and in part curved (in the part corresponding to the bottom 72 of the throat 71). The throat 71 is adapted to cooperate with a projection suitably created in the coupling surface of the lower jaw element 35.

FIG. 9 illustrates a sixth variant of the flange 21 that differs from the one illustrated in FIG. 8 in that the cylindrical portion 70 of the coupling surface 31 is interrupted at the middle plane π by a projection 71′ instead of by a throat. In particular, the projection 71′ has a square section, so that the generatrix line of the surface of revolution 31 comprises steps, but alternatively it could also be rounded and/or joined to the cylindrical portion 70. The projection 71′ is adapted to cooperate with a throat suitably created in the coupling surface of the lower jaw element 35.

FIG. 10 illustrates a seventh variant of the flange 21 that differs from the one illustrated in FIG. 8 in that the throat 71 has a flat bottom 72 that joins to the cylindrical portion 70 gradually.

The throats 71 and the projection 71′ of the variants illustrated in FIGS. 8, 9, and 10 could, alternatively, be made in association with surfaces of revolution different to cylindrical surfaces as in, for example, the surfaces of revolution 31 illustrated in FIGS. 3, 4, 5, 6, and 7, thus obtaining other variants of the seat post of the present invention.

It will be understood that the geometries illustrated above for the throats can be used to form projections and vice-versa, just as other geometries are also possible.

Further alternatives consist of forming more than one throat or more than one projection, and/or of forming the throats and the projections 71 and 71′ in a position not coinciding with the middle plane π as in, for example on the outer edges of the cylindrical portion 70.

The variants described above share the feature that the coupling surfaces between flange 21 and lower jaw element 35 are symmetrical with respect to the middle plane π. Actually, the coupling surfaces can also have a different configuration, but still such as to form stop means of the lower jaw element 35 that prevent its lateral movement with respect to the flange 21.

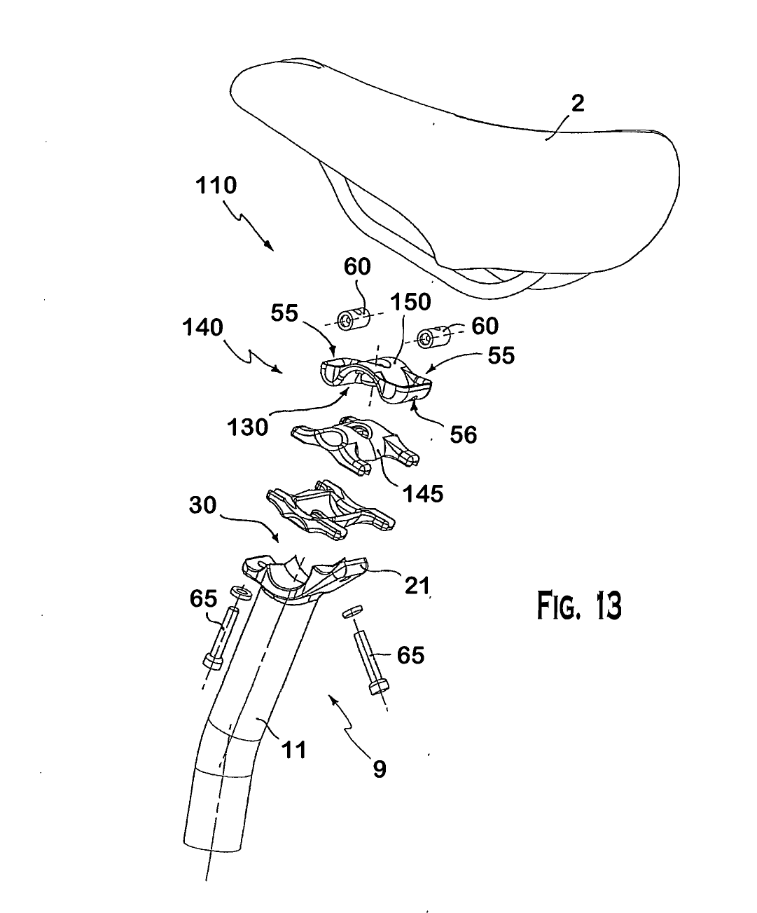

FIG. 13 illustrates an alternative embodiment of a seat post according to the present invention, in particular, the seat post 110 of FIG. 13 differs from the seat post 10 illustrated in FIG. 2 mainly for the shape of the upper jaw element 140 which, instead of being monolithic, is divided into two components. A first component 145 is identical to the lower jaw element 35, and is interchangeable with it. A second component 150 comprises the recesses 55 for housing the cylinder nuts 60 and the holes 56 for the passage of the screws 65. The second component 150 is in practice a mobile flange that encloses the first element as described in U.S. patent application Ser. No. 11/639,481, filed Dec. 14, 2006, to the same Applicant. It should be noted that a coupling seat 130 identical to the coupling seat 30 of the flange 21 is formed on the mobile flange 150. In addition, it is possible to provide means for coupling in rotation with the first component 145 in the coupling seat 130 again as described in patent application U.S. patent application Ser. No. 11/639,481, filed Dec. 14, 2006 to the same Applicant.

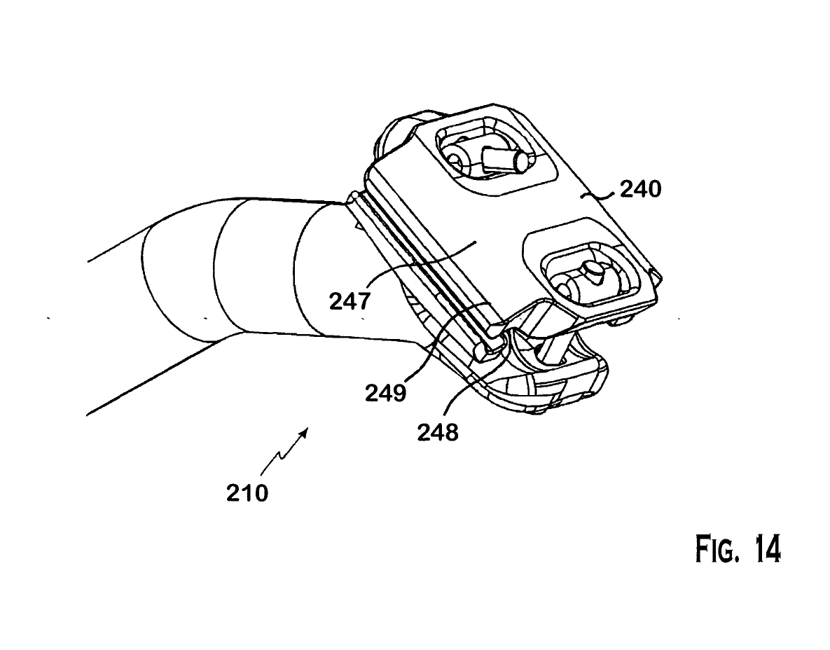

FIG. 14 illustrates a further alternative embodiment of a seat post according to the present invention. In particular, the seat post 210 of FIG. 14 differs from the seat post 10 of FIG. 2 in the shape of the upper jaw element 240, that is substantially squared. More specifically, there are no more arms, but the tracks 248 are formed on a peripheral portion 249 solidly connected to the main body 247 of the upper jaw element 240 along the entire length of the tracks. All the other elements are as in the embodiment of FIG. 2 and have like reference numbers. This shape results in a particularly strong upper jaw element and, therefore, it is preferred when the upper jaw element is made of composite material.

Preferably, the seat posts according to the present invention are at least partially, and even more preferably totally, made from composite material, comprising structural fibers incorporated in a polymeric material. Typically, the structural fibers are selected from the group consisting of carbon fibers, glass fibers, aramid fibers, ceramic fibers, boron fibers, and combinations thereof, carbon fibers being preferred. Preferably, the polymeric material is thermosetting. However, the possibility of using a thermoplastic material is not excluded. More preferably, the polymeric material comprises an epoxy resin.

The arrangement of the structural fibers in the polymeric material can be a random arrangement of pieces or sheets of structural fibers, a substantially unidirectional ordered arrangement of fibers, a substantially bidirectional ordered arrangement of fibers, an arrangement with woven fibers, or a combination of the above.

Alternatively, all of the components of the seat post, or just a part thereof, can be made from metallic material such as light alloys, preferably aluminum alloys.

It should be observed that the coupling seat 30 and the front and rear fins 25 and 26 have been described up to now as forming part of a flange 21. Actually, the presence of the flange should not be considered as an essential feature of the invention, with the coupling seat 30 being adapted to be formed, for example, directly on the end 20 of the tubular element 11, and the front or rear fins 25 and 26 being adapted to project directly from the edge of the tubular element or be replaced by a through pin as described in patent U.S. Pat. No. 5,190,346.

What is claimed is:

1. Bicycle seat post, comprising:
a tubular element adapted to support a saddle of a bicycle, and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
wherein the tubular element comprises first holding surfaces of the clamp and the clamp comprises second holding surfaces operatively coupled with the first holding surfaces to prevent a movement of the clamp along the axis.

2. Seat post according to claim 1, wherein the tubular element further comprises a seat for coupling with the clamp, the first holding surfaces being defined in the coupling seat, and wherein the clamp comprises a coupling member coupled with the coupling seat, the second holding surfaces being defined in the coupling member.

3. Seat post according to claim 2, wherein the coupling seat comprises a surface of revolution about the axis and wherein the first holding surfaces are defined by at least one portion of the surface of revolution.

4. Seat post according to claim 3, wherein the coupling member comprises an abutment surface having a shape matching that of the surface of revolution and wherein the second holding surfaces are defined by at least one portion of the abutment surface.

5. Seat post according to claim 3, wherein the surface of revolution is defined by the rotation about the axis of a generatrix line having at least one inclined part with respect to the axis and wherein the at least one portion of the surface of revolution is defined by the rotation about the axis of the at least one inclined part.

6. Seat post according to claim 5, wherein the generatrix line has two inclined parts with respect to the axis, the inclined parts having opposite inclination with respect to the plane of longitudinal symmetry of the frame of the bicycle.

7. Seat post according to claim 5, wherein the at least one inclined part is a rectilinear part.

8. Seat post according to claim 4, wherein the at least one portion of the surface of revolution and the at least one portion of the abutment surface comprise respective conical surfaces that extend along the axis.

9. Seat post according to claim 5, wherein the at least one inclined part is a curvilinear part.

10. Seat post according to claim 9, wherein the at least one portion of the surface of revolution and the at least one portion of the abutment surface comprise respective curved surfaces that extend along the axis.

11. Seat post according to claim 3, wherein the at least one portion of the surface of revolution defines, on a plane passing through the axis, a line having a substantially convex progression with respect to the axis.

12. Seat post according to claim 3, wherein the at least one portion of the surface of revolution defines, on a plane passing through the axis, a line having a substantially concave progression with respect to the axis.

13. Seat post according to claim 5, wherein the generatrix line is entirely inclined with respect to the axis.

14. Seat post according to claim 5, wherein the generatrix line comprises at least one part substantially parallel to the axis.

15. Seat post according to claim 14, wherein the at least one part substantially parallel to the axis is arranged at least one free end of the generatrix line.

16. Seat post according to claim 14, wherein the generatrix line comprises a gradual joining part between the at least one part substantially parallel to the axis and the at least one inclined part.

17. Seat post according to claim 3, wherein the surface of revolution comprises at least one first portion of cylindrical surface extending along the axis and a second portion of cylindrical surface extending along the axis and having a diameter different to that of the at least one first portion of cylindrical surface, wherein the first holding surfaces are defined by the second portion of cylindrical surface.

18. Seat post according to claim 17, wherein the at least one first portion of cylindrical surface is arranged at a free end of the surface of revolution and the second portion of cylindrical surface is arranged at the plane of longitudinal symmetry of the frame of the bicycle.

19. Seat post according to claim 17, wherein the second portion of cylindrical surface has a diameter larger than that of the at least one first portion of cylindrical surface.

20. Seat post according to claim 17, wherein the second portion of cylindrical surface has a diameter smaller than that of the at least one first portion of cylindrical surface.

21. Seat post according to claim 17, wherein the surface of revolution comprises a gradual joining surface between the at least one first portion of cylindrical surface and the second portion of cylindrical surface.

22. Seat post according to claim 4, wherein the surface of revolution and the abutment surface are symmetrical with respect to the plane of longitudinal symmetry of the frame of the bicycle.

23. Seat post according to claim 2, wherein the tubular element further comprises, at a free end thereof, a first flange comprising the coupling seat and, on opposite sides to the coupling seat, a pair of fins extending cantilevered from the coupling seat.

24. Seat post according to claim 4, wherein the clamp comprises an upper jaw element and a lower jaw element, and the coupling member is defined by the lower jaw element.

25. Seat post according to claim 24, wherein the tubular element further comprises, at a free end thereof, a first flange comprising the coupling seat and, on opposite sides to the coupling seat, a pair of fins extending cantilevered from the coupling seat, and the clamp further comprises a second flange adapted to be coupled with the first flange through fasteners, wherein the upper jaw element and the lower jaw element are arranged between the first flange and the second flange.

26. Seat post according to claim 25, wherein the second flange is made in a single piece with the upper jaw element.

27. Seat post according to claim 25, wherein the second flange is made in a distinct piece from the upper jaw element.

28. Seat post according to claim 27, wherein the upper jaw element and the lower jaw element are mirror-like elements.

29. Seat post according to claim 1, wherein the tubular element is made from a light metallic alloy.

30. Seat post according to claim 1, wherein the tubular element is made from composite material.

31. Seat post according to claim 1, wherein the clamp is made from the same material from which the tubular element is made.

32. Seat post according to claim 1, wherein the clamp comprises an upper jaw element and a lower jaw element, both having tracks thereon to fit on the portion of the seat to be clamped, the tracks of the upper jaw element being formed on a peripheral portion solidly connected to a main body of the upper jaw element along the entire length of the tracks.

33. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising
first holding surfaces of the clamp and the clamp comprising second holding surfaces operatively coupled with the first holding surfaces to prevent a movement of the clamp along the axis, and
a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface.

34. A bicycle seat post according to claim 33, wherein the at least one portion of the surface of revolution defines, on a plane passing through the axis, a line having a substantially convex progression with respect to the axis.

35. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising
first holding surfaces of the clamp and the clamp comprising second holding surfaces operatively coupled with the first holding surfaces to prevent a movement of the clamp along the axis, and
a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface wherein the at least one portion of the surface of revolution and the at least one portion of the abutment surface comprise respective conical surfaces that extend along the axis.

36. A bicycle seat post according to claim 35, wherein the at least one portion of the surface of revolution defines, on a plane passing through the axis, a line having a substantially convex progression with respect to the axis.

37. A bicycle seat post according to claim 35, wherein
the clamp comprises an upper jaw element and a lower jaw element,
the coupling member is defined by the lower jaw element,
the tubular element further comprises, at a free end thereof, a first flange comprising the coupling seat and, on opposite sides to the coupling seat, a pair of fins extending cantilevered from the coupling seat,
the clamp further comprises a second flange adapted to be coupled with the first flange through fasteners,
the clamp is arranged between the first flange and the second flange, and
the second flange is made in a single piece with the upper jaw element.

38. The bicycle seat post according to claim 35, wherein the tubular element is made from composite material.

39. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle, the clamp comprising a coupling member, the coupling member comprising an abutment surface,
the tubular element comprising
first holding surfaces of the clamp and the clamp comprising second holding surfaces operatively coupled with the first holding surfaces to prevent a movement of the clamp along the axis, and
a seat for coupling with the clamp, the coupling seat comprising a surface of revolution about the axis,
wherein at least one portion of the surface of revolution and at least one portion of the abutment surface comprise respective conical surfaces that extend along the axis.

40. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle, the clamp comprising a coupling member, the coupling member comprising an abutment surface,
the tubular element comprising
first holding surfaces of the clamp and the clamp comprising second holding surfaces operatively coupled with the first holding surfaces to prevent a movement of the clamp along the axis, and
a seat for coupling with the clamp, the coupling seat comprising a surface of revolution about the axis,
wherein at least one portion of the surface of revolution and at least one portion of the abutment surface comprise respective conical surfaces that extend along the axis, and
the at least one portion of the surface of revolution defines, on a plane passing through the axis, a line having a substantially convex progression with respect to the axis.

41. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising
first holding surfaces of the clamp and the clamp comprising second holding surfaces operatively coupled with the first holding surfaces to prevent a movement of the clamp along the axis, and
a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface wherein the at least one portion of the surface of revolution and the at least one portion of the abutment surface comprise respective conical surfaces that extend along the axis,
the clamp comprises an upper jaw element and a lower jaw element, and the coupling member is defined by the lower jaw element,
the tubular element further comprises, at a free end thereof, a first flange comprising the coupling seat and, on opposite sides to the coupling seat, a pair of fins extending cantilevered from the coupling seat, and the clamp further comprises a second flange adapted to be coupled with the first flange through fasteners,
the clamp is arranged between the first flange and the second flange, and
the second flange is made in a single piece with the upper jaw element.

42. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising
first holding surfaces of the clamp and the clamp comprising second holding surfaces operatively coupled with the first holding surfaces to prevent a movement of the clamp along the axis, and
a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface
wherein the at least one portion of the surface of revolution and the at least one portion of the abutment surface comprise respective conical surfaces that extend along the axis,
the at least one portion of the surface of revolution defines, on a plane passing through the axis, a line having a substantially convex progression with respect to the axis,
the clamp comprises an upper jaw element and a lower jaw element,
the coupling member is defined by the lower jaw element,
the tubular element further comprises, at a free end thereof, a first flange comprising the coupling seat and, on opposite sides to the coupling seat, a pair of fins extending cantilevered from the coupling seat,
the clamp further comprises a second flange adapted to be coupled with the first flange through fasteners,
the clamp is arranged between the first flange and the second flange, and
the second flange is made in a single piece with the upper jaw element.

43. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising
first holding surfaces of the clamp and the clamp comprising second holding surfaces operatively coupled with the first holding surfaces to prevent a movement of the clamp along the axis, and
a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface
wherein the at least one portion of the surface of revolution and the at least one portion of the abutment surface comprise respective conical surfaces that extend along the axis,
the clamp comprises an upper jaw element and a lower jaw element, and the coupling member is defined by the lower jaw element,
the tubular element further comprises, at a free end thereof, a first flange comprising the coupling seat and, on opposite sides to the coupling seat, a front fin and a rear fin, each fin extending cantilevered from the coupling seat, and the clamp further comprise a second flange adapted to be coupled with the first flange through fasteners,
the clamp is arranged between the first flange and the second flange,
the second flange is made in a single piece with the upper jaw element, and
the fasteners comprise screws extending parallel to the plane of longitudinal symmetry of the frame of the bicycle through holes defined by the front fin and the rear fin, respectively.

44. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising
first holding surfaces of the clamp and the clamp comprising second holding surfaces operatively coupled with the first holding surfaces to prevent a movement of the clamp along the axis, and
a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface wherein the at least one portion of the surface of revolution and the at least one portion of the abutment surface comprise respective conical surfaces that extend along the axis,
the at least one portion of the surface of revolution defines, on a plane passing through the axis, a line having a substantially convex progression with respect to the axis,
the clamp comprising an upper jaw element and a lower jaw element,
the coupling member is defined by the lower jaw element,
the tubular element further comprises, at a free end thereof, a first flange comprising the coupling seat and, on opposite sides to the coupling seat, a pair of fins extending cantilevered from the coupling seat,
the clamp further comprises a second flange adapted to be coupled with the first flange through fasteners,
the clamp is arranged between the first flange and the second flange,
the second flange is made in a single piece with the upper jaw element, and
the fasteners comprise screws extending parallel to the plane of longitudinal symmetry of the frame of the bicycle through holes defined by the front fin and the rear fin, respectively.

45. A bicycle seat post comprising:
a tubular element adapted to support a saddle of a bicycle; and
a clamp of a portion of a frame of the saddle adapted to be rotatably coupled with the tubular element to allow the clamp to be positioned in a plurality of operating positions defined about an axis perpendicular to a plane of longitudinal symmetry of a frame of the bicycle,
the tubular element comprising a seat for coupling with the clamp, the first holding surfaces being defined in the coupling seat, and the clamp comprising a coupling member coupled with the coupling seat, the second holding surfaces being defined in the coupling member, the coupling seat comprising a surface of revolution about the axis, the first holding surfaces being defined by at least one portion of the surface of revolution, and the coupling member comprising an abutment surface having a shape matching that of the surface of revolution, and the second holding surfaces being defined by at least one portion of the abutment surface,
wherein the at least one portion of the surface of revolution and the at least one portion of the abutment surface comprise respective conical surfaces that extend along the axis,
the clamp comprises an upper jaw element and a lower jaw element, and the coupling member is defined by the lower jaw element,
the tubular element further comprises, at a free end thereof, a first flange comprising the coupling seat,
the clamp further comprises a second flange adapted to be coupled with the first flange through fasteners, and
the second flange is made in a single piece with the upper jaw element.

46. A bicycle seat post comprising:
a tubular element adapted to support a saddle of a bicycle;
a single-piece upper jaw element; and
a lower jaw element of a portion of a frame of the saddle adapted to be rotatably coupled with the tubular element to allow the upper jaw element and lower jaw element to be positioned in a plurality of operating positions defined about an axis perpendicular to a plane of longitudinal symmetry of a frame of the bicycle,
the tubular element comprising a coupling seat comprising a surface of revolution about the axis, and the coupling member is defined by the lower jaw element,
the coupling seat comprising two conical surfaces that extend along the axis.
